(19) United States
(12) Patent Application Publication
(10) Pub. No.: US 2024/0240789 A1
(43) Pub. Date: Jul. 18, 2024

(54) RECUPERATIVE BURNER FOR A THERMAL PROCESS AIR TREATMENT DEVICE

(71) Applicant: Dürr Systems AG, Stuttgart, Bietigheim-Bissingen (DE)

(72) Inventors: Björn BEEH, Ludwigsburg (DE); Thomas BAUMANN, Pforzheim (DE); Sven MEYER, Bingen am Rhein (DE); Erhard RIEDER, Herrenberg (DE)

(21) Appl. No.: 18/562,051

(22) PCT Filed: May 19, 2022
(86) PCT No.: PCT/DE2022/100386

§ 371 Date: Nov. 17, 2023

(30) Foreign Application Priority Data
May 21, 2021 (DE) 10 2021 113 266.5

(51) Int. Cl. F23G 7/06; B01D 53/34; B01D 53/72; B01D 53/76

(52) U.S. Cl. CPC F23G 7/066; B01D 53/343; B01D 53/72; B01D 53/76; B01D 2257/702; F23G 2206/10

(57) ABSTRACT

A recuperative burner (20) for introducing a process air (A) to be treated into the combustion space (15) of the combustion chamber of a thermal process air treatment device (10) and for discharging the flue gas (E) from the combustion space (15) comprises a heat transfer sector (40) having an internal space (46) in which a plurality of process air tubes (43) for introducing the process air (A) to the combustion space (15) extend. It is proposed to equip the recuperative burner (20) with at least one flue gas tube (60) for discharging the flue gas (E) from the combustion space (15), comprising an open input opening (61) in the combustion space (15) and passing into the heat transfer sector (40) and comprising, in the section inside the heat transfer sector (40), at least one tube wall opening (63) for introducing the flue gas (E) into the internal space (46) of the heat transfer sector (40), through which the process air tubes (43) pass, for the purpose of heat transfer from the discharging flue gas (E) to the inflowing process air (A).

### RELATED APPLICATIONS

This application is a national Phase of International Application No. PCT/DE2022/100386 filed on May 19, 2022, and claims the benefit of German Application No. 2021 133 266.5 filed on May 21, 2023, both of which are incorporated herein by reference in their entirety and for all purposes.

### FIELD OF DISCLOSURE

Examples disclosed herein relate to a recuperative burner for a thermal process air treatment device, for example usable as a thermal, in particular recuperative thermal exhaust air or exhaust gas cleaning device. Such thermal process air treatment devices can advantageously be used in connection with industrial production processes in which mainly organic substances (e.g. hydrocarbons) are released, which must be treated by thermal oxidation to protect people and the environment. For example, they can be used for cleaning pollutants from an exhaust air from a workpiece processing system (e.g., painting plant of car bodies), for lean gas combustion (e.g. in landfill or biogas environment, etc.), for generation of inert gas, for example, for desorption of zeolite concentrators, but also for various other purposes or other systems.

### BACKGROUND

For example, workpiece processing systems often have to be equipped with a thermal exhaust air purification in order to meet the applicable legal requirements for cleaning hydrocarbons from an exhaust air from, for example, dryer systems, as part of immission control. Most concepts known to date for thermal process air treatment have a combustion chamber, in whose combustion space oxidation of the process air takes place, and a burner to ensure the required oxidation temperature. The burner is often designed as a recuperative burner in which a heat transfer system is integrated to preheat the entire process air or only partial streams by heat transfer with the hot flue gas from the combustion space in order to still obtain an increased combustion chamber temperature with reduced primary energy consumption. For the recuperative burners, there are also so-called tube bundle heat exchangers on the market, among others, which are integrated into the burner or coupled to the burner and which realize large heat transfer surfaces.

### SUMMARY

Meanwhile, there are several applications in industry where extremely high process air volume flows have to be thermally treated. It is therefore the object of examples disclosed herein to provide an improved recuperative burner for a thermal process air treatment device, which can also be used for high process air volume flows with a good heat transfer function of the hot flue gas on the process air to be treated.

This object is achieved by a recuperative burner for a thermal process air treatment device having the features of independent claim 1. Particularly advantageous configurations and developments of examples disclosed herein are the subject matter of the dependent claims.

The recuperative burner for a thermal process air treatment device having a combustion chamber with a combustion space therein for thermally treating a process air is configured for introducing a process air to be treated into the combustion space of the combustion chamber and for discharging a flue gas produced by thermal treating the process air from the combustion space of the combustion chamber with heat transfer from the discharging flue gas to the inflowing process air. The recuperative burner has a connecting sector comprising at least one process air input channel for receiving the process air and at least one flue gas output channel for outputting the flue gas; and a heat transfer sector comprising an input manifold attached to the connecting sector and a support element facing the combustion space of the combustion chamber, between which there is an internal space in which a plurality of process air tubes extend from the input manifold to the support member to guide the process air from the connecting sector to the combustion space, the process air tubes being coupled (directly or indirectly) through the input manifold to the at least one process air input channel of the connecting sector and being open through the support element in the direction towards the combustion space. According to examples disclosed herein, the recuperative burner further has at least one flue gas tube for discharging the flue gas from the combustion space, the at least one flue gas tube comprising an open input opening in the combustion space and passing through the support element of the heat transfer sector into the heat transfer sector and comprising, in the section inside the heat transfer sector, at least one tube wall opening for introducing the flue gas into the internal space of the heat transfer sector through which the process air tubes pass for the purpose of the heat transfer from the discharging flue gas to the inflowing process air. The internal space of the heat transfer sector is coupled (directly or indirectly) in its end region facing the connecting sector to the at least one flue gas output channel to discharge the flue gas from the heat transfer sector and from the burner.

Whereas in conventional process air treatment devices with a flue gas introduced from the combustion chamber from the outside into the heat transfer sector, in the case of a larger dimension of the heat transfer sector with a larger number of process air tubes, which is necessarily set up for the processing of larger process air volume flows, the hot flue gas only reaches a part of the process air tubes on that sector side of the inlet opening and thus achieves the heat transfer only on a part of the introducing process air, in the construction of the recuperative burner according to examples disclosed herein, the hot flue gas from the combustion space can flow into the heat transfer sector from the inside through the at least one flue gas tube, which, even in the case of a larger dimension of the heat transfer sector with a larger number of process air tubes, results that the flue gas reaches (almost) all the process air tubes and thus ensures a more uniform heat transfer to the (almost) complete incoming process air. The recuperative burner according to examples disclosed herein is thus also suitable for the treatment of larger process air volume flows of, for example, several 10,000 Nm³/h and also up to well over 100,000 Nm³/h, since the required heat transfer from the hot flue gas to the introducing process air can also be ensured with correspondingly larger dimensioning of the burner and its heat transfer sector. However, the recuperative burner according to examples disclosed herein can of course also be used in an advantageous manner for applications with lower process air volume flows, for example in the range of only a few 1,000 Nm³/h.

The flue gas tube preferably has several tube wall openings on different sides of the tube and/or several tube wall openings at different longitudinal points of the tube, whereby the hot flue gas is introduced into the interior of the heat transfer sector in an even more distributed manner, which, in the case of a larger dimension of the heat transfer sector with a larger number of process air tubes, even more effectively achieves that the flue gas reaches (almost) all process air tubes and thus ensures a more uniform heat transfer to the (almost) complete introducing process air. The cross-sectional shape and the dimensioning of the flue gas tube are basically arbitrary (i.e., not necessarily round), and optionally variable in the running direction (e.g., slightly conical) and can, for example, be freely adapted to the required process air quantities and temperature values depending on the application. The flue gas tube can also be designed with essentially the same structuring (diameter and/or cross-sectional shape and/or material) as the process air tubes of the heat transfer sector, which advantageously allows a very compact structure of the heat transfer sector, and wherein this is particularly advantageous in the presence of several flue gas tubes.

In a possible variant embodiment of examples disclosed herein, the burner has only a single flue gas tube, which is then preferably positioned substantially centrally (unless the center is used otherwise, for example by an additive tube, as explained later). Preferably, a plurality of flue gas tubes may be provided for discharging flue gas from the combustion space, each extending through the support element of the heat transfer sector into the heat transfer sector and comprising at least one tube wall opening in the section within the heat transfer sector for introducing the flue gas into the interior of the heat transfer sector for heat transfer from the discharging flue gas to the introducing process air, the plurality of flue gas tubes preferably being symmetrically distributed in the cross-section of the heat transfer sector. By incorporating several flue gas tubes, the advantages explained above can be achieved even more effectively. If several flue gas tubes are present, all flue gas tubes or groups of several flue gas tubes can optionally each have a common input section with a single input opening for the flue gas.

The heat transfer sector of the recuperative burner is to be understood in this context as a spatially limited section of a room, pipe, duct, etc., in particular with a certain length and scope delimited by walls. The input manifold of the heat transfer sector designates in this context the delimitation of the heat transfer sector at its front side to the connection sector, and the holding element of the heat transfer sector designates in this context the delimitation of the heat transfer sector at its front side to the combustion space, wherein the input manifold and/or the holding element can in this respect also project into the connection sector or the combustion space or can be arranged within the connection sector or the combustion space, depending on the embodiment of the recuperative burner. The heat transfer sector is basically closed on its outer circumferential side and preferably also sealed on at least one of its two front sides (for example preferably on the input manifold, but not necessarily on the mounting element). The mounting element of the heat transfer sector on its front side facing the combustion space essentially serves to position the process air tubes relative to one another and, in this context, can be structured in a tightly closing manner or have openings or be completely open. The process air tubes running through the heat transfer sector are preferably connected at their ends through the end faces of the heat transfer sector to the connection sector of the burner or the combustion space of the combustion chamber in such a way that the process air flows through the heat transfer sector essentially only within the process air tubes from the process air input channel of the connection sector to the combustion space of the combustion chamber and the flue gas flows through the heat transfer sector as far as possible only outside the process air tubes from the flue gas tube to the flue gas output channel of the connection sector. The heat transfer sector preferably has a substantially circular or elliptical or polygonal (e.g., rectangular, hexagonal, octagonal) cross-sectional shape that provides fluidic advantages. For larger burner dimensions, the heat transfer sector is preferably widened in only one (i.e., not all) cross-sectional directions, so that it preferably has an elliptical (i.e. non-circular) or rectangular (i.e. non-square) cross-sectional shape. In this way, even in the case of larger heat transfer sectors with more process air tubes (due to the requirement of higher process air volume flows), a better/more evenly distributed import of the flue gas from the combustion space into the heat transfer sector and also with constant inflow velocities is obtained. The cross-sectional shape of the flue gas tube is basically arbitrary, for example essentially circular. In the manufacture of the recuperative burner according to examples disclosed herein, the lengths of the heat transfer sector and its process air tubes can be designed variably, in order to adapt the burner and thus also the corresponding process air treatment device to temperature requirements of the process air and the flue gas, depending on the application.

The heat transfer sector with the process air tubes may also be referred to as a tube bundle heat exchanger, which is known to provide large heat transfer surfaces for those skilled in the art. In this context, however, the present disclosure is not limited to specific structures or dimensions of the process air tubes of a tube bundle heat exchanger. For example, however, in the present disclosure, the process air tubes may also have upset (i.e., non-round) profiles and integral spacers therebetween. Advantageously, the process air tubes may be arranged in parallel alignment in the heat transfer sector, at least in sections. Thereby, they can be, at least in sections, straight, axially and/or radially curved. For ease assembly, the process air tubes are thereby preferably arranged with uniform distances to respective adjacent process air tubes. However, it can also be advantageous in terms of flow, if the process air tubes are arranged within the heat transfer sector, in particular over a cross-section of the heat transfer sector, in a selected pattern around the flue gas tube. A preferred pattern may thereby vary with increasing distance from the flue gas tube, for example increasing or decreasing outwardly. In another variant embodiment, it can be provided to arrange process air tubes located radially further outwardly offset from process air tubes located further inwardly by a certain circumferential angle. In a particularly preferred embodiment variant, the process air tubes are arranged in the manner of a Fibonacci series around the flue gas tube. In another embodiment variant, the process air tubes can extend at least in sections in a circular, arcuate, elliptical or spiral shape along the flue gas tube in order to increase the efficiency and/or uniformity of the heat transfer in this way and/or to improve, in particular to equalize, the flow of flue gas to the process air tubes.

In one embodiment of examples disclosed herein, the heat transfer sector of the recuperative burner in its end region facing the combustion space, further comprises at least one additional lead-in opening in its outer circumferential region for introducing the flue gas from the combustion space into the internal space of the heat transfer sector through which the process air tubes pass. This measure allows the flue gas to be introduced into the internal space of the heat transfer sector in cross-sectional orientation from the inside and from the outside, so that the hot flue gas reaches (almost) all the process air tubes even more reliably, and thus ensuring more uniform temperature distribution and heat transfer to the (almost) complete introducing process air as well as avoiding even more reliably temperature hot spots and associated material stresses. The additional outer inlet opening can be provided, for example, in the edge area of the support element or in the outer peripheral wall of the heat transfer sector.

In one embodiment of examples disclosed herein, the recuperative burner further comprises a flame tube provided at the side of the support element of the heat transfer sector facing away from the internal space (e.g. as part of the support element or as a separate component attached to the support element) to introduce the process air into the combustion space via the flame tube, the flue gas tube extending through the flame tube and through the support element of the heat transfer sector into the heat transfer sector. The flame tube improves a uniform process air supply from the process air tubes into the combustion space and a targeted thermal treatment of the process air in the combustion space compared to a direct contact of the combustion space with the holding element of the heat transfer sector. The flame tube achieves increased speeds, higher turbulence and thus improved mixing of the flows (process air, fuel, possibly combustion air mixture, possibly additives) from the heat transfer sector, whereby combustion can be realized with simultaneously low Nox emissions. In addition, the flame tube ensures a minimum residence time of the process air required for the reactions. In the design of the recuperative burner with the additional external inlet opening, this would then be positioned outside the flame tube in the support element and accessible via a discharge gap between the combustion chamber housing and the outer wall of the connection tube or, if in outer peripheral wall of the heat transfer sector, accessible via a discharge gap between the combustion chamber housing and the outer wall of the connection tube and further the outer wall of the heat transfer sector.

In one embodiment of examples disclosed herein, the flue gas tube projects into the heat transfer sector only along a partial section and has a closed tube end wall. In this way, the hot flue gas is introduced from the flue gas tube into the interior of the heat transfer sector only in the area of the heat transfer sector facing the combustion space and is then discharged from the interior to the flue gas output channel in the area of the heat transfer sector facing the connection sector.

In another embodiment of examples disclosed herein, the flue gas tube extends through the entire heat transfer sector to the input manifold and comprises a closed tube end wall. In this case, at least one of the at least one tube wall opening for introducing the flue gas into the internal spacer of the heat transfer sector is arranged in the half of the heat transfer sector facing the connecting sector, and the heat transfer sector comprises, in its end region facing the connecting sector, at least one lead-out opening on its outer circumference which is coupled to the at least one flue gas output channel. The flue gas tube can have at least one tube wall opening only in the half of the heat transfer sector facing the connecting sector or optionally additionally have at least one tube wall opening in the half of the heat transfer sector facing the combustion space, in each case for introducing the hot flue gas into the internal space of the heat transfer sector.

In yet another embodiment of examples disclosed herein, the flue gas tube extends through the entire heat transfer sector and through the input manifold and comprise a tube partition wall between the region of the support element and the region of the input manifold to form a lead-in section facing the support element and a discharge section facing the input manifold, the discharge section being coupled to the at least one flue gas output channel, wherein the at least one tube wall opening for introducing the flue gas into the internal space of the heat transfer sector is arranged in the lead-in section, and wherein the flue gas tube comprises at least one further tube wall opening in its discharge section for discharging/receiving the flue gas from the internal space of the heat transfer sector into the flue gas tube. In this embodiment variant, the flue gas tube may preferably be constructed in one piece with the flue gas output channel.

Optionally, the recuperative burner further comprises (i) at least one actuator configured and arranged to selectively at least partially block the flue output channel; and/or (ii) at least one actuator configured and arranged to selectively at least partially block at least one of the at least one flue gas tube. Alternatively or additionally, the recuperative burner optionally further comprises (iii) at least one variator configured and arranged to selectively at least partially restrict access to at least one of the at least one tube wall opening of the flue gas tube (for introducing the flue gas from the flue gas tube into the internal space of the heat transfer sector); and/or (iv) at least one variator configured and arranged to selectively at least partially restrict access to at least one of the at least one further tube wall opening of the flue gas tube (for discharging the flue gas from the internal space of the heat transfer sector back into the flue gas tube), if present; and/or (v) at least one variator configured and arranged to selectively at least partially restrict access to at least one of the at least one additional lead-in opening into the internal space of the heat transfer sector (in its outer peripheral region), if present; and/or (vi) at least one variator configured and arranged to selectively at least partially open the tube partition wall between the lead-in section and the discharge section of the flue gas tube, if present. The actuators can be used in each case to control how much flue gas flows through the flue gas tube and the heat transfer sector, and the variators can be used in each case to control how much flue gas enters the internal space of the heat transfer sector. By means of these optional elements, the degree of recuperation of the heat transfer sector can thus be advantageously adjusted/controlled in each case. The mentioned actuators may each be adjustable, for example, manually, electrically, pneumatically, electromagnetically and/or hydraulically, and the actuators may each be configured, for example, in such a way that the at least partial blocking of the flue gas output channel or the flue gas tube takes place by an axial displacement of the actuator or by means of a rotatable element having holes, flaps, etc. The variators can each, for example, also be manually, electrically, pneumatically, electromagnetically and/or hydraulically adjustable, and the variators can each, for example, be axially displaceable or rotatable.

In one embodiment of examples disclosed herein, the heat transfer sector may have at least one discharge opening at a location between the support element and the input manifold at its outer periphery for discharging a portion of the flue gas from the internal space of the heat transfer sector into a flue gas discharge channel (i.e., prior to discharge of the flue gas from the internal space of the heat transfer sector to the flue gas output channel of the connection sector). In this way, a portion of the flue gas is discharged into the flue gas output channel that is less cooled than the flue gas discharged into the flue gas output channel of the connection sector, so that, if required, more heat can be transferred from the flue gas downstream of the process air treatment device at other points (e.g. heat exchangers of a workpiece processing system, heat supply for heat transfer fluid system, heat supply for generating electrical energy, etc.) and for this purpose also an additional hot gas discharge from the combustion space of the process air treatment device can be omitted. In addition, this partial flue gas discharge reduces the temperature of the process air tubes in the area near the connection sector, so that the process air tubes can preferably be made at least partially of a less heat-resistant material (e.g., less expensive stainless steel) in the area between the discharge opening and the connection sector, so that the manufacturing costs for the process air tubes and thus also for the entire recuperative burner can be reduced. The discharge opening is also preferably equipped with a flow controller for selectively setting a flue gas discharge quantity. By regulating the flue gas discharge quantity in this way, the temperature in the heat transfer sector area facing the connection sector and also the temperature of the discharged flue gas can be regulated according to application requirements.

In one embodiment of examples disclosed herein, the heat transfer sector may additionally include in its internal space a plurality of flow guide structures in the form of, for example, baffles, each oriented transversely to the process air tubes and each having through openings for passing the process air tubes therethrough, the plurality of baffles being spaced apart from each other in the running direction of the process air tubes and being offset from each other in the direction transverse to the running direction of the process air tubes. By these baffles, the flue gas introduced into the internal space of the heat transfer sector is deflected back and forth along the longitudinal direction of the heat transfer sector, so that it reaches all of the process air tubes in the outer region and the inner region of the heat transfer sector. In this embodiment, the flue gas tube has the at least one tube wall opening for introducing the flue gas into the internal space, preferably in the end region of the heat transfer sector facing the support element. The orientation of the baffles is basically at any angle to the running direction of the process air tubes (i.e., not necessarily perpendicular), preferably at least about 45 degrees to the running direction of the process air tubes.

In one embodiment of examples disclosed herein, the connecting sector further comprises at least one fuel input channel for receiving a fuel (e.g., natural gas) and a premixing space for mixing the process air and the fuel to a combustion air mixture, wherein the process air tubes of the heat transfer sector are coupled to the premixing space through the input manifold to direct the combustion air mixture from the connection sector to the combustion space. The premixing of the process air with fuel allows ignition of the combustion air mixture as it enters the combustion chamber without an additional igniter. This simplifies the design of the combustion chamber and also the burner. For this purpose, the combustion space can be supplied with thermal energy in a simple manner by a heating device (e.g., an electrical or electromagnetic heating device or a switchable high-temperature heat source of another type), so that the combustion air mixture preheated by the heat transfer sector then immediately reaches a combustion temperature. In this embodiment variant, one or more safety measures are preferably taken to safely prevent ignition of the combustion air mixture in the premixing space of the connection sector. A safety measure may be that the connection sector further comprises at least one temperature detection device (e.g., temperature sensor such as a thermocouple, IR sensor, pyrometer, etc.) for detecting a temperature of the combustion air mixture in the premixing space. When excessive temperature is detected by the temperature detection device, ignition in the premixing space can be prevented by shutting off the process air supply and the fuel supply and then blowing out the remaining fuel gas mixture in the premixing space through the heat transfer sector into the combustion space. In addition, the process air pipes at the input manifold of the heat transfer sector are each preferably fixed in a sealed manner, whereby an inflow of the flue gas from the internal space of the heat transfer sector into the premixing space of the connecting sector can be prevented and thus a temperature rise and thus ignition in the premixing space can be more reliably prevented. A further safety measure can be that the process air tubes are each tapered at their end facing the combustion space, whereby the process air is directed at an angle in the direction of the combustion space and this swirl prevents the hot flue gas from flowing back from the combustion space into the process air tubes, thus creating a dynamic flame arrestor to reliably prevent a temperature rise and thus ignition in the premixing space.

In another embodiment of examples disclosed herein, the connecting sector further comprises at least one fuel input channel for receiving a fuel (e.g. hydrogen), and the burner further comprises at least one fuel tube coupled (directly or indirectly) to the at least one fuel input channel and extending either (i) between the process air tubes or (ii) within a process air tube through the internal space of the heat transfer sector to direct the fuel separately to the process air from the connecting sector into the combustion spacer. Due to the separate supply of the fuel to the combustion space, ignition can already be prevented within the heat transfer sector and therefore hydrogen (with higher reactivity), for example, can also be used as fuel instead of natural gas, without a higher flow rate being required to prevent ignition already in the heat transfer sector, since the hydrogen is not ignited alone, but only when mixed with the process air after flowing out of the heat transfer sector to the combustion space. The separate fuel tube (in both variants) is preferably not or only insignificantly longer than the process air tubes, so that the hydrogen does not initially become hot alone after flowing out of the fuel tube (whereby nitrogen oxides can be resulted), but is immediately flowed over by the outflowing process air, whereby the generation of nitrogen oxides is prevented or at least reduced and emission values can thereby be reduced. The fuel tube can optionally be designed to be at least somewhat thermally insulated, so that the respective fuel, if required, can be passed through the flue gas to the combustion space, without or at least with less heating. For example, premature ignition can be avoided in this way even when a very highly flammable fuel is used.

The two aforementioned embodiments of examples disclosed herein having a premixing space and a fuel input channel, respectively, can optionally also be combined with each other. In this way, for example, two different fuels can be fed into the combustion space, for example natural gas via the premixing space and the process air tubes and hydrogen via the at least one fuel tube. This use of different fuels can be carried out together in one application or individually in different applications.

In yet another embodiment of examples disclosed herein, the connecting sector does not have a fuel input channel for receiving a fuel, so that no fuel is delivered to the combustion space of the combustion chamber by the recuperative burner. This embodiment is applicable to styles of the thermal process air treatment device in which the combustion chamber has its own fuel supply, which may optionally be combined with an ignition mechanism.

In a further embodiment of examples disclosed herein, the connecting sector may further comprise at least one additive input channel for receiving an additive (e.g. ignition agent or other process media), and the burner may further comprise at least one additive tube coupled (directly or indirectly) to the at least one additive input channel and extending through the heat transfer sector adjacent to the process air tubes in order to introduce an additive into the combustion chamber in addition to the process air.

In a further embodiment of examples disclosed herein, the process air tubes can each be loosely coupled into the support element of the heat transfer sector. This measure allows the process air tubes to slide individually through the support element into the combustion space in the event of elongation due to a temperature effect.

If the recuperative burner also comprises a flame tube for introducing the process air into the combustion space of the combustion chamber, as explained above, the flame tube and/or the flue gas tube preferably comprise outer circumferential walls which are configured and oriented such that the space enclosed by the flame tube is expanded in the direction from the support element of the heat transfer sector to the combustion space of the combustion chamber (which may also be referred to as a diffuser). This embodiment variant is particularly advantageous in the embodiment with the process air tubes loosely coupled into the holding element of the heat transfer sector. By widening the space in the direction towards the combustion space, the pressure in the direction towards the combustion space is increased in relation to the pressure near the support element, so that the pressure difference between inside and outside the internal space of the heat transfer sector is reduced and thus a direct backflow of the process air or the combustion air mixture from the process air tubes through the gaps in the support element around the process air tubes into the internal space of the heat transfer sector and thus mixing with the flue gas can be avoided.

In a further embodiment of examples disclosed herein, the support element of the heat transfer sector preferably comprises, adjacent to the process air tubes, at least one additional opening in which a twister is arranged for obliquely returning gas (flue gas, process air, combustion air mixture) from the internal space of the heat transfer sector into the flame tube. By such a recirculation of the gas into the combustion space, the thermal process air treatment is carried out again, which is particularly important if part of the process air flows back into the internal space of the heat transfer sector without treatment. This embodiment variant is particularly advantageous for the embodiment with a diffuser variant of the flame tube.

Alternatively or additionally, at least a subset of the process air tubes may also have a flame stabilizer, for example in the form of an external ring after their outlet opening.

In a further embodiment of examples disclosed herein, the connecting sector comprises at least one valve device for selectively opening or closing and optionally also for throttling a respective input channel (process air/fuel/additive) for switching on or off burner operation and influencing the amount of process air to be processed. In the case of several valve devices, in particular also in the case of several valve devices for the same type of input channel, these are preferably controllable independently of one another.

In yet further embodiment of examples disclosed herein, the recuperative burner may further comprise a differential pressure measuring device across the heat transfer sector. Based on the differential pressure measuring device, impurities in the heat transfer sector can be detected and thus cleaning processes can be planned/initiated.

In the recuperative burner according to examples disclosed herein, the heat transfer sector may optionally also consist of a plurality of heat transfer sector segments, wherein the plurality of heat transfer sector segments each contain at least one flue gas tube and/or at least one flue gas tube is disposed between at least two heat transfer sector segments. The plurality (i.e., two or more) of heat transfer sector segments may be configured and arranged coaxially with respect to each other, for example, or may be arranged adjacent to each other. The multiple heat transfer sector segments are preferably each coupled to their own input channels and can be controlled independently of each other (for example, by the above-mentioned valve devices), so that a distribution of the process air flow rate can be flexibly controlled to the multiple heat transfer sector segments and in this way the recuperative burner can be operated in multiple stages.

All of the above explained embodiments of the recuperative burner can be combined in virtually any may within the scope of examples disclosed herein.

An object of examples disclosed herein also is a thermal process air treatment device comprising a combustion chamber having a combustion space therein for thermally treating a process air and at least one recuperative burner of examples disclosed herein described above. With this thermal process air treatment device, the same advantages as explained above with respect to the recuperative burner of examples disclosed herein can be achieved. Moreover, all the above-mentioned embodiments and their possible combinations of the recuperative burner are applicable, if necessary depending on the application of the process air treatment device.

The thermal process air treatment device can—depending on the application—optionally have a single recuperative burner or a plurality (i.e., two or more) of recuperative burners. In the case of multiple recuperative burners, these are preferably controllable independently of each other (for example, by the above-mentioned valve devices at the input channels), so that a distribution of the process air flow rate among the multiple burners and/or an operating number of the multiple burners can be flexibly controlled. In the case of several recuperative burners, these can—depending on the application of the device and/or depending on the embodiment of the burners—for example be arranged directly next to each other or be arranged at a distance from each other.

The combustion chamber may comprise a combustion chamber housing, and the one recuperative burner or the arrangement of multiple recuperative burners may be surrounded by a burner wall. In one embodiment, the burner wall may be a component of the burner or the burner assembly and may be attachable to the combustion chamber housing via at least one burner flange. In another embodiment, the burner wall may be a component of the combustion chamber housing, and the burner or the burner assembly may be attachable to the burner wall via at least one burner flange. In the second mentioned embodiment with the integration of the walls of the components of the process air treatment device, an integrated construction unit or at least integrated partial construction units for the device can be created, which simplifies the installation of the device at the respective application.

In one embodiment of examples disclosed herein, the combustion chamber comprises at least one heating device (e.g., an electrical or electromagnetic heating device or a switchable high-temperature heat source of another type) for supplying thermal energy to the combustion chamber. By this measure, the premixed combustion air mixture preheated by the heat transfer sector, or the combustion air mixture formed from process air and fuel separately passed and preheated through the heat transfer sector, can then immediately reach a combustion temperature without the need for an additional ignition mechanism.

The thermal process air treatment device according to examples disclosed herein can basically be used for any applications/treatments/plants. The thermal process air treatment device can be used, for example, as a thermal, in particular recuperative thermal exhaust air or exhaust gas cleaning device, for example to clean pollutants (e.g. organic substances such as hydrocarbons) from an exhaust air from a workpiece processing system (e.g. for drying/curing/hardening of painted and/or coated and/or bonded workpieces such as car bodies or car body parts, for example, in the form of continuous dryers, continuous hardening plants, chamber dryers or chamber hardening plants), for lean gas combustion (e.g. in landfill or biogas environment, etc.), for generating inert gas, for example, for desorption of zeolite concentrators. However, examples disclosed herein is not limited to these specific applications.

An object of examples disclosed herein also is a method for operating the above-discussed recuperative burner according to examples disclosed herein, in particular in the above-discussed thermal process air treatment device according to examples disclosed herein. This method of operation includes the steps of introducing a process air to be treated through the recuperative burner (through connecting sector and heat transfer sector) into the combustion space of the combustion chamber; thermally treating (in particular, thermally oxidizing) the introduced process air in the combustion space to form a flue gas; and discharging the resulting flue gas from the combustion space via the flue gas tube and through the recuperative burner with heat transfer to the introducing process air in the heat transfer sector and via the flue gas output channel.

### BRIEF DESCRIPTION OF THE FIGURES

The above and other features and advantages of examples disclosed herein will become more apparent from the following description of preferred, non-limiting embodiments with reference to the accompanying drawings. Therein show, mostly schematically:

FIG. 1 a sectional view of a thermal process air treatment device having a recuperative burner according to a first exemplary embodiment of examples disclosed herein;

FIG. 2 a sectional view of a thermal process air treatment device having a recuperative burner according to a second exemplary embodiment of examples disclosed herein;

FIG. 3 a sectional view of a thermal process air treatment device having a recuperative burner according to a third exemplary embodiment of examples disclosed herein;

FIG. 4 a cross-sectional view of a variant of a heat transfer sector for the recuperative burners of FIGS. 1-3;

FIG. 5A a partial section view of a recuperative burner for illustrating a first variant of the third exemplary embodiment of FIG. 3;

FIG. 5B a partial sectional view of a recuperative burner for illustrating a second variant of the third exemplary embodiment of FIG. 3;

FIG. 6 a sectional view of a thermal process air treatment device having a recuperative burner according to a fourth exemplary embodiment of examples disclosed herein;

FIG. 7 a sectional view of a thermal process air treatment device having a recuperative burner according to a fifth exemplary embodiment of examples disclosed herein;

FIG. 8 a sectional view of a thermal process air treatment device having a recuperative burner according to a modified fifth exemplary embodiment of examples disclosed herein;

FIG. 9 a sectional view of a thermal process air treatment device having a recuperative burner according to a sixth exemplary embodiment of examples disclosed herein n;

FIG. 10 a sectional view of a thermal process air treatment device having a recuperative burner according to a seventh exemplary embodiment of examples disclosed herein;

FIG. 11 a cross-sectional view of a first variant of the recuperative burner having a group of multiple heat transfer sector segments;

FIG. 12 a cross-sectional view of a second variant of the recuperative burner having a group of multiple heat transfer sector segments;

FIG. 13 a partial sectional view of a recuperative burner according to an eighth exemplary embodiment of examples disclosed herein;

FIG. 14 a partial sectional view of a recuperative burner according to a modified eighth exemplary embodiment of examples disclosed herein;

FIG. 15 sketches to illustrate a thermal process air treatment device having multiple recuperative burners according to a first embodiment of examples disclosed herein;

FIG. 16 sketches to illustrate a thermal process air treatment device having multiple recuperative burners according to a second embodiment of examples disclosed herein; and

FIG. 17 a flowchart to illustrate the operating procedure of the recuperative burner according to an exemplary embodiment of examples disclosed herein.

### DETAILED DESCRIPTION

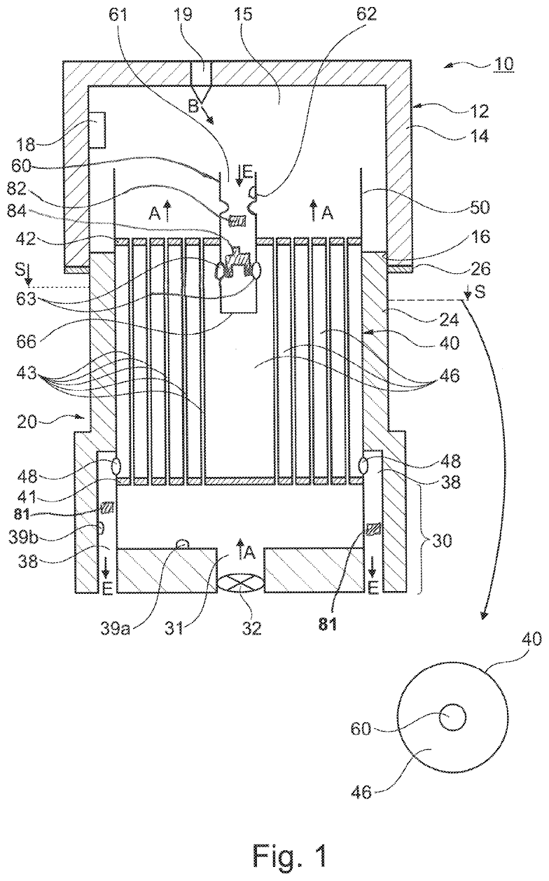

Referring to FIG. 1, a first exemplary embodiment of a recuperative burner according to examples disclosed herein and a thermal process air treatment device having such a burner are exemplarily illustrated in more detail.

The thermal process air treatment device 10 has a combustion chamber 12 with a combustion chamber housing 14 which therein comprises a combustion space 15 for thermally treating (e.g., oxidizing) a process air A (e.g., exhaust air from a workpiece machining system). As indicated in FIG. 1, the combustion chamber 12 is in this exemplary embodiment also provided with a fuel supply 19 for introducing a fuel B (e.g. natural gas or hydrogen) into the combustion space 15 and a heating device 18 (e.g. an electric or electromagnetic heating device or a switchable high-temperature heat source of another type) for supplying thermal energy to the combustion space 15 so that the process air A to be treated together with the supplied fuel B immediately reaches a combustion temperature without the need for an additional ignition mechanism. The process air treatment device 10 also has a recuperative burner 20 for introducing the process air A to be treated into the combustion space 15, and for discharging the flue gas E produced by the thermal treatment from the combustion space 15.

Optionally, the combustion chamber 12 may additionally comprise a hot gas outlet for diverting the hot flue gas E into hot gas exhaust (not shown). By such a discharge of the hot flue gas E from the combustion chamber 12, it is possible to withdraw energy from the combustion chamber 15 to avoid overheating or to supply additional energy from the combustion space 15 to other heat exchangers (e.g., for heating up a workpiece processing system).

The recuperative burner 20 has a connection sector 30 with at least one process air input channel 31, to which a process air line of the respective system, in which this device 10 is used, can be connected and which has a process air valve device 32 for selectively opening or closing and optionally also for throttling the process air input channel 31. The connecting sector 30 further comprises at least one flue gas output channel 38 for discharging the flue gas E from the burner 20 and the process treatment device 10. Optionally, the connecting sector 30 may further be connected to an air connection for introducing an air (e.g., fresh air).

The recuperative burner 20 further has a heat transfer sector 40 (tubular or channel-shaped in this embodiment). The heat transfer sector 40 comprises an input manifold 41 attached to the connecting sector 30, a support element 42 facing the combustion chamber 12, and an outer circumferential wall with an internal space 46 therebetween. The heat transfer sector 40 also integrates a plurality of process air tubes 43 extending from the input manifold 41 through the internal space 46 to the support element 42. As indicated in FIG. 1, the process air tubes 43 are, on the one hand, through the input manifold 41 coupled to the at least one process air input channel 31 and, on the other hand, through the support element 42 open to the combustion space 15 to direct the process air A introduced into the connecting sector 30 into the combustion space 15 of the combustion chamber 12. In this exemplary embodiment, also a flame tube 50 is attached to the support element 42 of the heat transfer sector 40, the outer walls of which are positioned in the region of the outer circumferential wall of the heat transfer sector 40, which is inserted into the combustion chamber 12 and through which the process air A from the process air tubes 43 is directed into the combustion space 15 of the combustion chamber 12.

The particular structures and dimensions of the process air tubes 43 are basically arbitrary. For example, in this exemplary embodiment, the process air tubes 43 may each extend substantially parallel to the central axis of the burner 20 from the input manifold 41 to the support member 42 and preferably have upset (i.e., non-circular) profiles and integral spacers therebetween. At the input manifold 41, the process air tubes 43 are preferably each fixed in a sealed manner so that only the internal spaces of the process air tubes 43 are connected to the process air input channel 31, but the internal spacer 46 of the heat transfer sector 40 around the process air tubes 43 is closed off from the connecting sector 30. At the support element 42, the process air tubes 43 may also protrude somewhat into the flame tube 50. In addition, the process air tubes 43 are not necessarily fixed in a sealed manner in the support element 42 in each case, but are preferably held loosely in each case so that they can be pushed individually into the combustion chamber 12, for example in the event of an elongation due to heat. Alternatively, the process air tubes 43 could also be lyre-shaped designed for this purpose. The ends of the process air tubes 43 on the support element 42 are also preferably tapered, so that the process air A is directed at an angle in the direction of the combustion space 15 and this swirl dynamically blocks a return of the flue gas E from the combustion space 15 into it.

The recuperative burner 20 further has at least one flue gas tube 60 for discharging flue gas E from the combustion space 15 of the combustion chamber 12. As shown in FIG. 1, the flue gas tube 60 comprises an open input opening 61 in the combustion space 15 for receiving the hot flue gas E. The flue gas tube 60 extends into the heat transfer sector 40 through the exit flange 42 of the heat transfer sector 40. In the section within the heat transfer sector 40, the flue gas tube 60 then has one or preferably several (preferably in different directions and/or at different longitudinal locations) tube wall openings 63 for introducing the hot flue gas E into the internal space 46 of the heat transfer sector 40 through which the process air tubes 43 pass, so that a heat transfer from the discharging flue gas E to the process air tubes 43 and thus to the introducing process air A takes place in the internal space 46 of the heat transfer sector 40. In its end region facing the connecting sector 30, the internal space 46 of the heat transfer sector 40 is then coupled to the at least one flue gas output channel 38 to discharge the flue gas E cooled through the internal space 46 from the heat transfer sector 40 and from the burner 20. By introducing the flue gas E by means of the flue gas tube 60 from the inner region of the heat transfer sector 40 in the cross-sectional plane into the internal space 46 of the heat transfer sector 40, the flue gas E reaches the inner and also outer process air tubes 43 in the internal space 46 in a very reliable manner in the cross-sectional plane, so that even in a large dimensioning of the heat transfer sector 40 with a very large number of process air tubes 43 for the purpose of processing large process air volume flows, a very effective heat transfer to the process air A takes place.

In this exemplary embodiment, the recuperative burner 20 comprises only a single flue gas tube 60 positioned approximately centrally, as indicated in the cross-sectional view S-S attached to FIG. 1. Alternatively, the recuperative burner 20 may include multiple (i.e., at least two) flue gas tubes 60. In this alternative embodiment, optionally all flue gas tubes or the groups of multiple flue gas tubes may each have a common inlet section with a single input opening 61 for the flue gas E. In the exemplary embodiment of FIG. 1, the flue gas tube 60 also protrudes only along a partial section a piece into the heat transfer sector 40 and has a closed tube end wall 66. Furthermore, in this exemplary embodiment, the heat transfer sector 40 has one or more outside lead-out openings 48 in its end region facing the connecting sector 30 for discharging the flue gas E from the internal space 46 of the heat transfer sector 40 into the at least one flue gas output channel 38.

The flue gas tube 60 can have any cross-sectional shape in principle, but has, for example, a substantially circular cross-sectional shape. The heat transfer sector 40 can also have any cross-sectional shape in principle, for example, a substantially circular or elliptical or polygonal (e.g., rectangular, hexagonal, octagonal) cross-sectional shape. At a larger dimension, the heat transfer sector 40 is preferably expanded in only one (i.e., not all) cross-sectional direction such that it has, for example, a substantially elliptical (i.e., non-circular) or rectangular (i.e., non-square) cross-sectional shape. Furthermore, the flue gas tube 60 may optionally be formed with substantially the same structuring (i.e., in particular diameter and/or cross-sectional shape and/or material) as the process air tubes 43 of the heat transfer sector 40, which is particularly advantageous in the presence of a plurality of flue gas tubes 60, and by which is possible advantageously a very compact structure of the heat transfer sector 40.

The dimension of the heat transfer sector 40 and the number of process air tubes 43 are adapted to the respective process air volume flows for which the device 10 is used. In addition, the length of the heat transfer sector 40 and the corresponding length of the process air tubes 43 can be adapted to the respective requirements for the temperatures of the process air A to be treated and the hot flue gas E.

For monitoring the operating state and the temperature conditions, the recuperative burner 20 preferably comprises, in the connecting sector 30, at least one temperature detection device 39a for detecting the temperature of the process air A introduced through the process air input channel 31, at least one temperature detection device 39b for detecting the temperature of the cooled flue gas E discharged from the internal space of the heat transfer sector 40, and/or in the inlet sector of the flue gas tube 60 at least one temperature detection device 62 for detecting the temperature of the flue gas E. For example, the temperature detection devices 39a, 39b, 62 may comprise a temperature sensor such as a thermocouple, an IR sensor, a pyrometer or the like. Although not shown, the recuperative burner 20 may optionally further include a differential pressure gauge across the heat transfer sector 40 to detect contamination.

In this exemplary embodiment, the recuperative burner 20 is circumferentially surrounded along its connecting sector 30 and its heat transfer sector 40 by a burner wall 24, which is attached to the combustion chamber housing 14 via at least one burner flange 26 after the burner 20 is inserted into the housing opening 16 of the combustion chamber 12.

As indicated in FIG. 1, the recuperative burner 20 may optionally have one or more additional elements 81, 82, 84 in order to adjust or control the degree of recuperation of the heat transfer sector 40 during operation of the recuperative burner. For example, at least one actuator 81 is provided in the flue gas output channel 38 which is configured to selectively at least somewhat block the flue gas output channel 38 and thus control the amount of flue gas flowing through the flue gas tube 60 and the heat transfer sector 40. Alternatively or additionally, there can also be at least one actuator 82 in the flue gas tube 60, which is designed to selectively block the flue gas tube 60 at least somewhat and thus regulate the quantity of flue gas flowing through the flue gas tube 60 and the heat transfer sector 40. The indicated actuators 81, 82 are each configured, for example, so that the at least partial blocking of the flue gas output channel 38 or the flue gas tube 60 can be carried out by an axial displacement of the actuator (for example, between sections of the output channel 38 or the flue gas tube 60 having different intersections, in which case a narrow section can be filled by the actuator) or by means of a rotatable element having holes, flaps, etc. And the indicated actuators 81, 82 are adjustable, for example, manually, electrically, pneumatically, electromagnetically and/or hydraulically. Furthermore, in addition or alternatively, a variator 84 may be present in the flue gas tube 60, which is arranged and configured to selectively at least somewhat restrict access in the flue gas tube 60 to at least one or preferably all of the tube wall openings 63, and thereby control how much flue gas E from the flue gas tube 60 enters the internal space 46 of the heat transfer sector 40 for heat transfer to the process air A in the process air tubes 43. For example, the indicated variator 84 is configured such that the at least partial obturation of the tube wall openings 63 is executable by an axial displacement or a rotation of the variator 84 within the flue gas tube 60. And the indicated variator 84 is also adjustable, for example, manually, electrically, pneumatically, electromagnetically, and/or hydraulically.

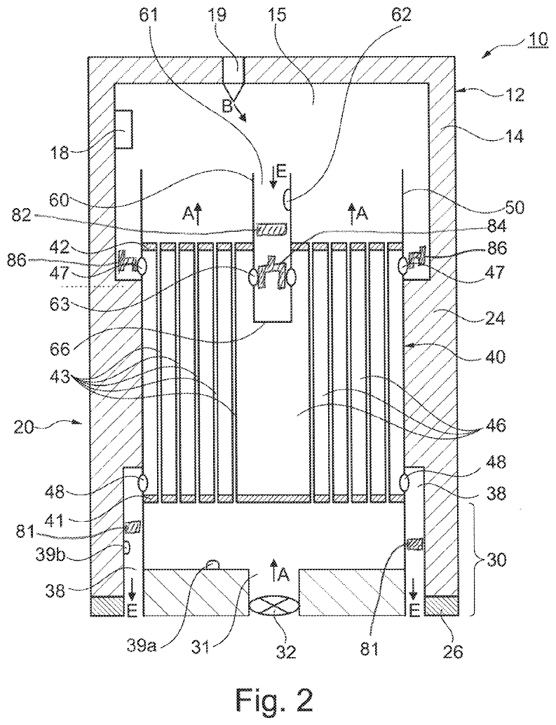

Referring to FIG. 2, a second exemplary embodiment of a recuperative burner according to examples disclosed herein and a thermal process air treatment device with such a burner are explained in more detail by way of example. Identical or corresponding components are indicated by the same reference numerals as in the first exemplary embodiment.

Compared to the first exemplary embodiment of FIG. 1, the heat transfer sector 40 of the recuperative burner 20 in this exemplary embodiment further comprises, in its end region facing the combustion chamber 12, at least one additional lead-in opening 47 in its outer circumferential region for introducing the hot flue gas E from the combustion space 15 of the combustion chamber 12 into the internal spacer 46 of the heat transfer sector 40. That is, in this exemplary embodiment, the hot flue gas E is introduced into the internal space 46 of the heat transfer sector 40 both from the inner region of the heat transfer sector 40 in the cross-sectional plane and from the outer region of the heat transfer sector 40 in the cross-sectional plane, so that the hot flue gas E reaches the inner and outer process air tubes 43 in the internal space 46 even more reliably, particularly in the case of larger dimensions of the burner, in order to ensure very effective heat transfer to the process air A even when processing very large process air volume flows. In this exemplary embodiment, the additional lead-in opening 47 is provided in the outer circumferential wall of the heat transfer sector 40. In an alternative embodiment, the additional lead-in opening 47 can also be provided outside the connection tube 50 in the support element 42 of the heat transfer sector 40. In both variants, access from the combustion space 15 to the additional lead-in opening 47 is possible through a discharge gap between the combustion chamber housing 14 and the connection tube 50. As indicated in FIG. 2, analogous to the first exemplary embodiment of FIG. 1, the recuperative burner 20 may optionally comprise one or more actuators 81, 82 and/or variators 84 for adjusting or regulating the degree of recuperation of the heat transfer sector 40, wherein in this second exemplary embodiment there is also optionally at least one variator 86 which is arranged and configured in such a way that it can selectively at least somewhat restrict the access to the respective additional lead-in opening 47 of the flue gas E and can thus regulate how much and in which outer circumferential region flue gas E passes from the combustion space 15 into the internal space 46 of the heat transfer sector 40. These indicated variators 86 are also configured, for example, such that the at least partial obturation of the respective additional lead-in opening 47 is executable by an axial displacement or a rotation of the variator 86.

In addition, this exemplary embodiment differs from the first exemplary embodiment in that the burner wall 24 circumferentially surrounding the connecting sector 30 and the heat transfer sector 40 is configured as an integral part of the combustion chamber housing 14. After being inserted into this combustion chamber housing 14+24, the recuperative burner 20 is attached to the burner wall 24 of the combustion chamber housing 14 via at least one burner flange 26 (for example in the region of the connecting sector 30).

Furthermore, this exemplary embodiment corresponds to the first exemplary embodiment of FIG. 1, which is why no further construction descriptions are provided.

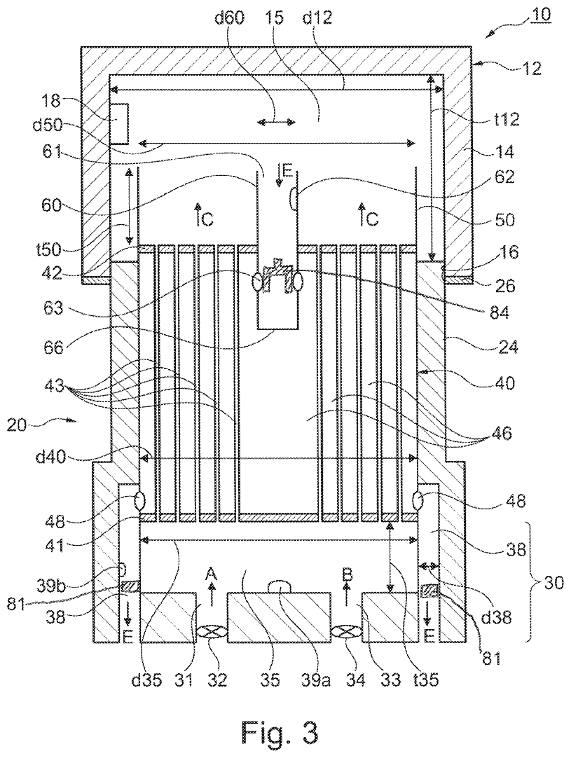

Referring to FIG. 3, a third exemplary embodiment of a recuperative burner according to examples disclosed herein and of a thermal process air treatment device with such a burner are explained in more detail by way of example. Identical or corresponding components are marked with the same reference numerals as in the previous exemplary embodiments.

Compared to the first exemplary embodiment of FIG. 1, the connecting sector 30 of the recuperative burner 20 comprises, in addition to the at least one process air input channel 31, at least one fuel input channel 33 for receiving a fuel B (e.g., natural gas). The fuel input channel 33 also preferably comprises a fuel valve device 34 in order to be able to selectively open or close the fuel input channel 33 and optionally also to throttle it. In addition, the connecting sector 30 includes a premixing space 35 in which the process air A taken in through the process air input channel 31 and the fuel B taken in through the fuel input channel 33 are mixed to form a combustion air mixture C. Optionally, in addition, an air (e.g., fresh air) can be introduced into the premixing space 35 via a corresponding air connection. To support the mixing, the premixing space 35 can optionally also be equipped with turbulence-promoting components/devices (not shown). The process air tubes 43 of the heat transfer sector 40 are connected to this premixing space 35 by the input manifold 41, so that the process air tubes 43 guide the combustion air mixture C through the heat transfer sector 40 to the connection tube 50 and to the combustion space 15. In this exemplary embodiment, the temperature detection device 39a of the connecting sector 30 monitors the temperature of the combustion air mixture C in the premixing space 35. Since in this exemplary embodiment the fuel required for the thermal process air treatment is fed into the combustion space 15 through the recuperative burner 20, the other fuel supply 19 of the combustion chamber 12 can be dispensed with. As indicated in FIG. 3, also this recuperative burner 20, analogous to the previous exemplary embodiments, may optionally comprise one or more actuators 81, 82 and/or variators 84.

Due to the premixing space 35 and the joint introduction of process air A with fuel B, a safety concept must be in place to prevent ignition of the combustion air mixture C in the premixing space 35 by an unintentional inflow of hot flue gas from the combustion space 15 of the combustion chamber 12 into the premixing space 35 of the connecting sector 30 of the recuperative burner 20. This safety-concept is fulfilled, for example, by the features already described above with respect to FIG. 1, that (i) the process air tubes 43 are each tapered at their end facing the combustion chamber 12 in order to prevent the hot flue gas from the combustion chamber 15 into the process air tubes 43, (ii) the heat transfer sector 40 has at its end facing the premixing space 35 an input manifold 41 in contact with the premixing space 35, to which the plurality of process air tubes 43 are fixed in a sealed manner, and (iii) the connecting sector 35 has a temperature detection device 39a for detecting a temperature of the fuel gas mixture C in the premixing space 35 in order to be able to shut off the process air and fuel supply in good time if the temperature is too high.

In all other respects, this exemplary embodiment corresponds to the first exemplary embodiment of FIG. 1, which is why is dispensed with further design descriptions.

Furthermore, the third exemplary embodiment of FIG. 3 can be combined with the second exemplary embodiment of FIG. 2, i.e. the heat transfer sector 40 of the recuperative burner 20 can also be provided in the third exemplary embodiment of FIG. 3 with at least one additional lead-in opening 47 as described in the second exemplary embodiment of FIG. 2.

The dimension of the heat transfer sector 40 and the number of process air tubes 43 are adapted to the respective process air flow rates for which the device 10 is used. In addition, the length of the heat transfer sector 40 and the corresponding length of the process air tubes 43 can be adapted to the respective requirements for the temperatures of the combustion air mixture C and the hot flue gas E.

By way of example, with reference to FIG. 3, a few orders of magnitude of the dimensions of the components of this thermal process air treatment device 10 are now also given, which were present in a successfully tested embodiment. The values given can also be applied or adapted to the other exemplary embodiments. The combustion chamber 12 has an inner diameter d12 of about 1200 mm and a depth t12 of about 1500 mm. The flame tube 50 has a length t50 of about 600 and forms an exit space diameter d50 of about 650 mm (including diameter d60 of the flue gas tube 60 therein). The heat transfer sector 40 includes, for example, about 330 process air tubes 43 having an inside diameter of about 12 mm and an outside diameter of about 14 mm. The process air tubes 43 can project about 5 mm into the flame tube 50. The flue gas tube 60 has an inside diameter d60 of about 200 mm and a wall thickness of about 4 mm. The inner diameters d35, d40 of the premixing space 35 and the heat transfer sector 40 are each about 650 mm. The premixing space 35 has a depth t35 of about 300 mm. The input channels 31, 33 each have an inner diameter of about 250 mm and a length of about 1000 mm. The flue gas output channel 38 has an inside diameter d38 of about 100 mm. The numerical values given are, of course, only exemplary and can be modified, in particular, depending on the application. In addition, it is pointed out as a precaution that the illustration in FIG. 3 does not correspond at all points to the size ratios given here.

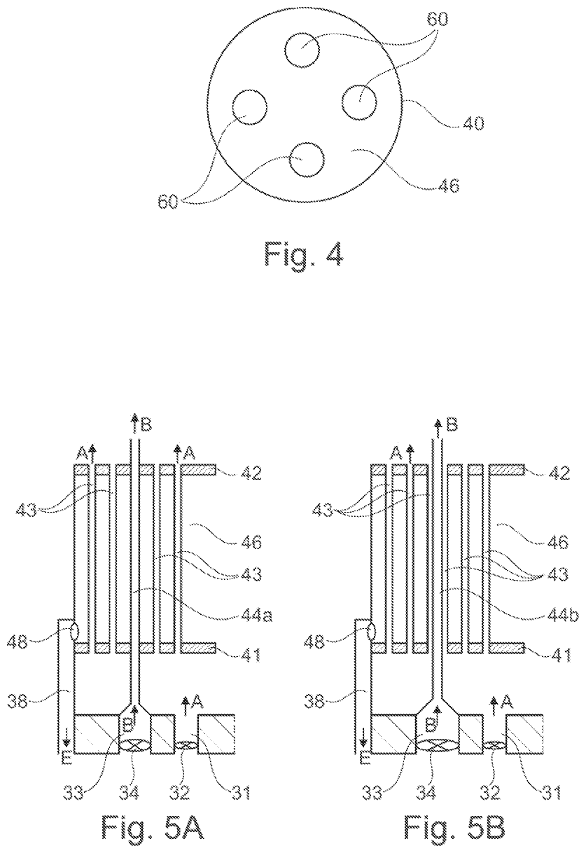

As noted above, in the first exemplary embodiment, the recuperative burner 20 includes a single flue gas tube 60 that is substantially centrally positioned. This statement is also true for the second and the third exemplary embodiments. However, as illustrated in FIG. 4, which shows a cross-sectional view analogous to S-S in FIG. 1, the recuperative burners 20 in all exemplary embodiments may alternatively comprise multiple (i.e., two or more, for example three or four) flue gas tubes 60 for introducing the hot flue gas E from the combustion space 15 of the combustion chamber 12 into the internal space 46 of the heat transfer sector 40. The multiple flue gas tubes 60 are preferably symmetrically distributed in the heat transfer sector 40. The use of multiple flue gas tubes 60 is particularly advantageous for larger sized heat transfer sectors 40. Optionally, all flue gas tubes 60 or groups of multiple flue gas tubes 60 may each have a common input section with a single input opening 61. In this case, it is then possible to position at least one actuator 82 in the respective common inlet section to optionally at least partially block the combined flue gas tubes 60.

With reference to FIGS. 5A and 5B, two variants of the third exemplary embodiment of FIG. 3 are explained in more detail by way of example. Identical or corresponding components are marked with the same reference numerals as in the third exemplary embodiment.

In contrast to the third exemplary embodiment of FIG. 3, the connecting sector 30 in these variants does not contain a premixing space 35. This means that the process air A taken in through the process air input channel 31 and the fuel B taken in through the fuel input channel 33 are not mixed to form a combustion air mixture C, but are conducted separately to the flame tube 50 and to the combustion space 15 via the heat transfer sector 40. By conducting process air A and fuel B separately, ignition of the process air A can already be prevented within the heat transfer sector 40 due to heating by the hot flue gas E. Furthermore, in these exemplary embodiments, hydrogen (instead of natural gas), for example, can also be used as fuel, which has a higher reactivity, without a higher flow rate to prevent ignition already in the heat transfer sector 40, since the hydrogen is only ignited when mixed with the process air in the combustion space 15.

Therefore, in both variants of FIGS. 5A and 5B, the process air tubes 43 of the heat transfer sector 40 are connected only to the at least one process air input channel 31 by the input manifold 41. In the first variant of FIG. 5A, in addition to the process air tubes 43, the heat transfer sector 40 also comprises at least one fuel tube 44a which extends between the plurality of process air tubes 43 through the internal space 46 of the heat transfer sector 40 from the input manifold 41 to the support element 42. In the second variant of FIG. 5A, in addition to the process air tubes 43, the heat transfer sector 40 additionally comprises at least one fuel tube 44b which extends within a process air tube 43 through the internal space 46 of the heat transfer sector 40 from the input manifold 41 to the support element 42. As shown in FIGS. 5A and 5B, the respective fuel tube 44a, 44b is directly connected to or even integrally formed with the fuel input channel 33. In the first variant of FIG. 5A, the fuel tube 44a protrudes through the support element 42 a little into the flame tube 50. In the second variant of FIG. 5B, the fuel tube 44b does not project beyond the process air tube 43 containing it, or only very slightly. When using hydrogen as fuel B, it is advantageous if the hydrogen is flowed over as quickly as possible by the process air A in order to prevent or at least reduce the generation of nitrogen oxides which can be generated when the hydrogen is heated without the process air in order to reduce the emission values of the device.

Incidentally, these two variants of the third exemplary embodiment also correspond to the first exemplary embodiment of FIG. 1, including options, and these two variants of the third exemplary embodiment can also be optionally combined with the second exemplary embodiment of FIG. 2.

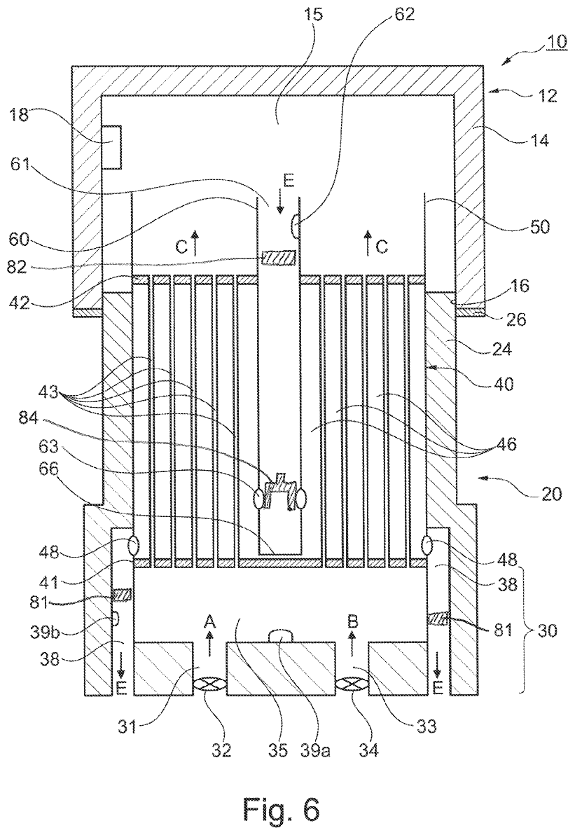

With reference to FIG. 6, a fourth exemplary embodiment of a recuperative burner according to examples disclosed herein and of a thermal process air treatment device having such a burner are explained in more detail by way of example. Identical or corresponding components are characterized with the same reference numerals as in the first exemplary embodiment.

In contrast to the third exemplary embodiment, the flue gas tube 60 extends through the entire heat transfer sector 40 to the input manifold 41, but also has a closed tube end wall 66. In addition, in contrast to the first exemplary embodiment, the tube wall openings 63 for introducing the hot flue gas E into the internal space 46 of the heat transfer sector 40 are located only in the half facing the connecting sector 30 or even only in the end region of the heat transfer sector 40 facing the connecting sector 30. For the subsequent discharge of the flue gas E from the internal space 46, the heat transfer sector 40 has, as in the first exemplary embodiment, at least one lead-out opening 48 coupled to the flue gas output channel 38 in its end region facing the connecting sector 30 at its outer circumference. The distance of the heat transfer in the internal spacer 46 of the heat transfer sector 40 from the flue gas E to the process air A is smaller in this exemplary embodiment than in the first exemplary embodiment, but this can be advantageous depending on the application if the flue gas E is not to lose as much heat and/or the process air is not to receive as much heat. As indicated in FIG. 6, this recuperative burner 20 optionally may also comprise one or more actuators 81, 82 and/or variators 84, analogous to the previous exemplary embodiments.

Incidentally, this embodiment corresponds to the third exemplary embodiment of FIG. 3, which is why to do without further design descriptions. Alternatively, this design of the flue gas tube 60 can also be integrated into the burner 20 of the first or the second exemplary embodiment of FIGS. 1 and 2, respectively.

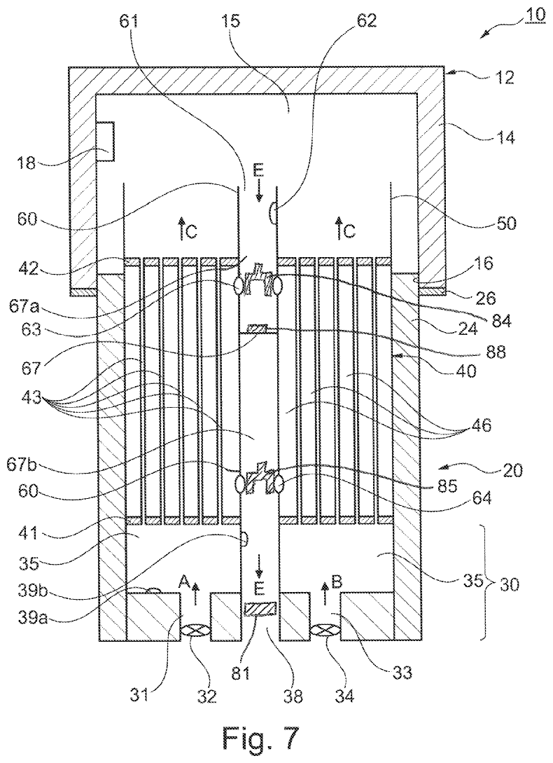

With reference to FIG. 7, a fifth exemplary embodiment of a recuperative burner according to examples disclosed herein and of a thermal process air treatment device having such a burner are explained in more detail by way of example. Identical or corresponding components are marked with the same reference numerals as in the previous exemplary embodiments.

In contrast to the third exemplary embodiment, the flue gas tube 60 extends through the entire heat transfer sector 40 and through the input manifold 41. While the flue gas tube 60 in the fourth exemplary embodiment of FIG. 6 has a closed tube end wall 66, the flue gas tube 60 is open at its end facing the connecting sector 30 and is connected to the flue gas output channel 38 or is even integrally formed with the flue gas output channel 38. The flue gas tube 60 has a closed outer circumferential wall when passing through the premixing space 35 of the connecting sector 30, so that the flue gas E cannot penetrate into the combustion air mixture C in the premixing space 35. Optionally, the flue gas tube 60 can also be thermally insulated in the area of the premixing space 35 so that no pre-reaction of the combustion air mixture C occurs. In addition, the flue gas tube 60 is divided by a tube partition wall 67 in the middle or upper region in the longitudinal direction of the heat transfer sector 40 into a lead-in section 67a facing the combustion space 15 of the combustion chamber 12, which comprises tube wall openings 63 for introducing the hot flue gas E into the internal space 46 of the heat transfer sector 40, analogously to the flue gas tube 60 of FIG. 3, and into a discharge section 67b facing the connecting sector 30, which is provided in the end region near the connecting sector 30 having further tube wall openings 64 for discharging the cooled flue gas E from the internal space 46 of the heat transfer sector 24 into the flue gas tube 60. In this exemplary embodiment, the discharge of the flue gas E from the internal space 46 takes place back into the flue gas tube 60 only in the inner region. Optionally, the heat transfer sector 40 could additionally comprise at least one lead-out opening 48 on its outer circumference, analogously to the exemplary embodiment of FIG. 3, which is coupled to another flue gas output channel that can optionally be merged with the flue gas outlet channel 38 connected to the flue gas tube 60. As indicated in FIG. 7, also this recuperative burner 20 may optionally include one or more actuators 81, 82 and/or variators 84, analogous to the previous exemplary embodiments. In this fifth exemplary embodiment, there is also optionally at least one variator 85 which is arranged and configured to selectively at least somewhat restrict access to at least one of the at least one further tube wall opening 64 and thereby control how much flue gas E passes from the internal space 46 of the heat transfer sector 40 back into the flue gas tube 60 to be discharged through the flue gas output channel 38. This indicated variator 85 is also configured, for example, in such a way that the at least partial obturation of the respective further tube wall opening 64 is executable by an axial displacement or a rotation of the variator 85. Furthermore, in this fifth exemplary embodiment, optionally there may also be present at least one variator 88 being arranged and configured in such way to selectively at least slightly open the tube partition wall 67 between the lead-in section 67a and the discharge section 67b of the flue gas tube 60 and thus control how much flue gas E flows only through the flue gas tube 60, i.e. without flowing through the internal space 46 of the heat transfer sector 40 to the flue gas output channel 38. This indicated variator 88 is configured, for example, such that the at least partial opening of the tube partition wall 67 is executable by an axial sliding out of the tube partition wall 67.

Incidentally, this embodiment corresponds to the third exemplary embodiment of FIG. 3, which is why to do without further design descriptions. Alternatively, this design of the flue gas tube 60 can also be integrated into the burner 20 of the first or the second exemplary embodiment of FIG. 1 or 2, respectively.

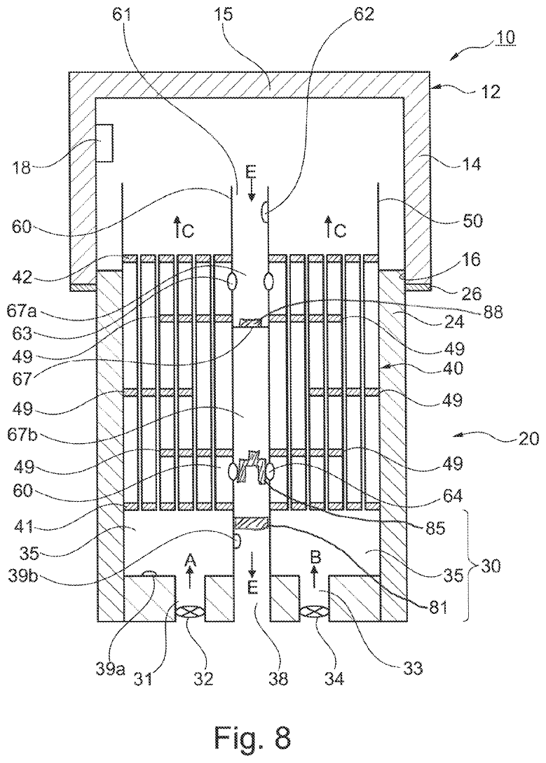

With reference to FIG. 8, a modification of the fifth exemplary embodiment of FIG. 7 is explained in more detail by way of example. Identical or corresponding components are marked with the same reference numerals as in the fifth exemplary embodiment.

In its internal space 46, the heat transfer sector 40 additionally has a plurality of baffles 49, each of which extends transversely (in this exemplary embodiment, substantially perpendicularly) to the process air tubes 43 over a portion of the internal space 46 and each of which has through-openings for passing the process air tubes 43 therethrough. The baffles 49 are clearly spaced apart from one another in the direction of travel of the process air tubes 43 and are arranged offset from one another transversely to the direction of travel of the process air tubes 43. The baffles 49 form flow guide structures in the internal space 46 of the heat transfer sector 40. These baffles 49 ensure that the heat transfer from the flue gas E to the combustion air mixture C does not take place in the manner of a counterflow heat exchanger, but that the flue gas E introduced from the flue gas tube 60 into the internal space 46 of the heat transfer sector 40 is deflected back and forth along the longitudinal direction of the heat transfer sector 40 and thus reaches all the process air tubes 43 in the outer region and in the inner region of the heat transfer sector 40.

Incidentally, this embodiment corresponds to the fifth exemplary embodiment of FIG. 7, for which reason no further design descriptions are provided. Moreover, this embodiment of the heat transfer sector 40 can also be combined with all other exemplary embodiments, i.e., the heat transfer sectors 40 of the other exemplary embodiment can also be equipped with such baffles 49. However, the use of the baffles 49 is particularly useful in those exemplary embodiments in which the flue gas tube 60 has its tube wall openings 63 for introducing the flue gas E into the internal space 46 of the heat transfer sector 40 in its half or end region facing the output flange 42, and in which the additional outer lead-in opening 47 for the flue gas E into the interior (see FIG. 2) is not present.

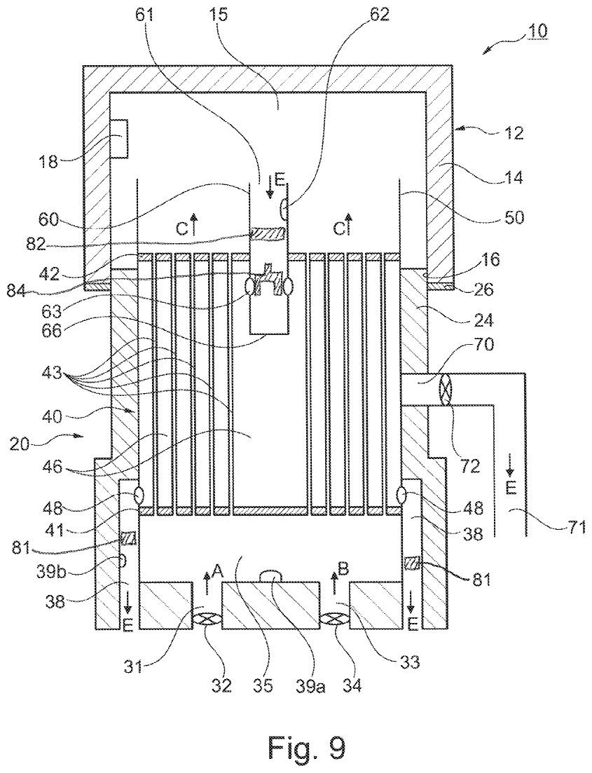

With reference to FIG. 9, a sixth exemplary embodiment of a recuperative burner according to examples disclosed herein and a thermal process air treatment device having such a burner are explained in more detail by way of example. Identical or corresponding components are marked by the same reference numerals as in the previous exemplary embodiments.

The sixth exemplary embodiment differs from the third exemplary embodiment of FIG. 3 in particular in the flow path of the hot flue gas. As shown in FIG. 9, the heat transfer sector 40 comprises at least one discharge opening 70 in its outer circumference at a point between the input manifold 41 and the support element 42, for example approximately in the middle region in the longitudinal direction, to which a flue gas discharge channel 71 is connected. Through this discharge opening 70, a partial quantity of the flue gas E, which has already been cooled somewhat by the heat transfer to the process air tubes 43, can be discharged from the heat transfer sector 40. The flue gas E flowing out via the flue gas discharge channel 71 thus has a higher temperature than the flue gas E flowing out via the flue gas output channel 38 of the connecting sector 30. Due to the higher temperature, if required, this flue gas quantity can then transfer more heat to other points (e.g., heat exchangers of a workpiece machining system) downstream of the process air treatment device 10. An additional hot gas discharge directly from the combustion chamber 12 (as mentioned above in connection with FIG. 1), which is otherwise frequently used for this purpose, can thus optionally be dispensed with. As indicated in FIG. 9, the discharge opening 70 is preferably also equipped with a flow regulator 72 for selectively adjusting the flue gas discharge quantity, whereby the temperature of the internal space 46 in the region of the heat transfer sector 40 facing the connecting sector 30 and the temperature of the discharged flue gas E in the flue gas discharge channel 71 can be controlled. While only one discharge opening 70 is shown in FIG. 9, the heat transfer sector 40 may also have several such discharge openings 70 along its circumference, which are connected to separate flue gas discharge channels 71 or to a common flue gas discharge channel 71.

In addition, by this design of a partial discharge of the flue gas E, a smaller amount of hot flue gas flows through the remainder of the internal space 46 of the heat transfer sector 40 toward the connecting sector 30. This also results in the temperature of the process air tubes 43 in the area near the connecting sector 30 being lower than without this partial discharge. Because of the resulting lower temperature load, the process air tubes 43 can be made of different materials in sections. In particular, the process air tubes 43 in the region between the discharge opening 70 and the connecting sector 30 can be manufactured at least partially (in particular close to the connecting sector 30) from a less expensive stainless steel, so that the manufacturing costs of the process air tubes 43 and thus also of the recuperative burner 20 can be reduced.

Incidentally, this exemplary embodiment corresponds to the third exemplary embodiment of FIG. 3, for which reason no further design descriptions are provided. Moreover, this embodiment of the heat transfer sector 40 can also be combined with all other exemplary embodiment, i.e., the heat transfer sectors 40 of the other exemplary embodiments can also be equipped with such a discharge opening 70. And as indicated in FIG. 9, also this recuperative burner 20 optionally may comprise one or more actuators 81, 82 and/or variators 84, analogously to the previous exemplary embodiments.

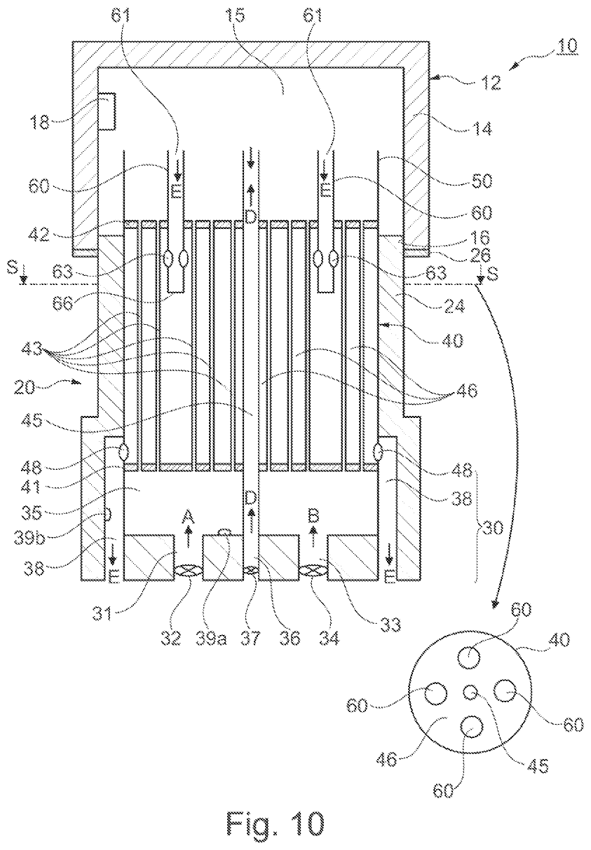

With reference to FIG. 10, a seventh exemplary embodiment of a recuperative burner according to examples disclosed herein and of a thermal process air treatment device having such a burner are explained in more detail by way of example. Identical or corresponding components are marked with the same reference numerals as in the previous exemplary embodiments.

In contrast to the third exemplary embodiment of FIG. 3, the recuperative burner 20, additionally to the combustion air mixture C, directs additive D (e.g., ignition agent and/or further process media for supporting the thermal process air treatment in the combustion space, such as VOC or air) into the combustion space 15 of the combustion chamber 12. For this purpose, the connecting sector 30 additionally comprises at least one additive input channel 36 for receiving an additive D, wherein the additive input channel 36 may also be provided with an additive valve device 37. In addition, the burner 20 additionally comprises at least one additive tube 45, which is coupled to the at least one additive input channel 36 through the input manifold 41 and extends, in addition to the process air tubes 43, through the entire heat transfer sector 40 into the flame tube 50 through the support element 42, in order to supply a corresponding additive C to the combustion space 15 in addition to the combustion air mixture C. In the exemplary embodiment of FIG. 10, a single additive tube 45 is provided as an example, which is positioned centrally in the heat transfer sector 40. For the most effective heat transfer from the flue gas E to the process air tubes 43, therefore, a plurality of flue gas tubes 60 is preferably provided, being positioned, for example, around the additive tube 45 in the heat transfer sector 40 (as also illustrated in the cross-sectional view S-S attached in FIG. 10).

Incidentally, this exemplary embodiment corresponds to the third exemplary embodiment of FIG. 3, for which reason no further design descriptions are provided. Although not indicated in FIG. 10, this recuperative burner 20 optionally may comprise have one or more actuators 81, 82 and/or variators 84, analogous to the previous exemplary embodiments.

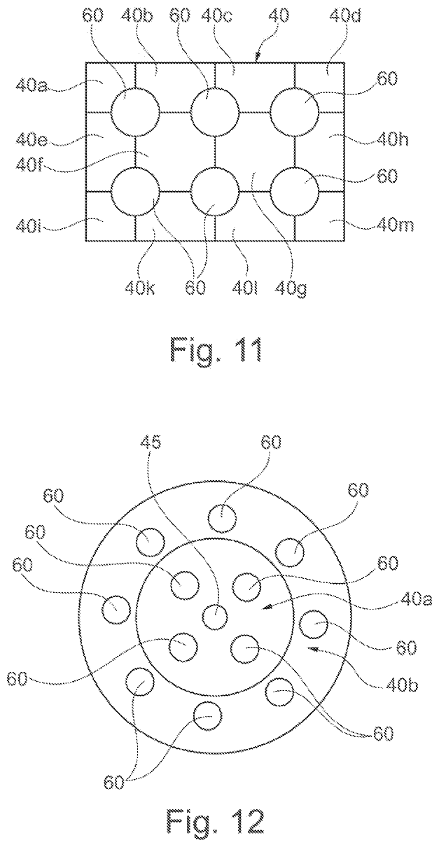

In FIGS. 11 and 12 there are designed exemplarily further design variants of the recuperative burner 20, in particular of its heat transfer sector 40. While in the above exemplary embodiments the heat transfer sector 40 is configured as a single structural unit in each case, the heat transfer sector 40 may also be composed of several (i.e., two or more) heat transfer sector segments 40n. By this measure, the recuperative burner 20 may be configured and operable in a multi-stage manner. The several heat transfer sector segments 40n are preferably each coupled to their own input channels 31, 33 in the connection sector 50, the valve devices 32, 34 of which are preferably controllable independently of one another, so that the sector segments 40n can be operated independently of one another in order to adapt the burner operation to the operating conditions (in particular the process air flow rate).

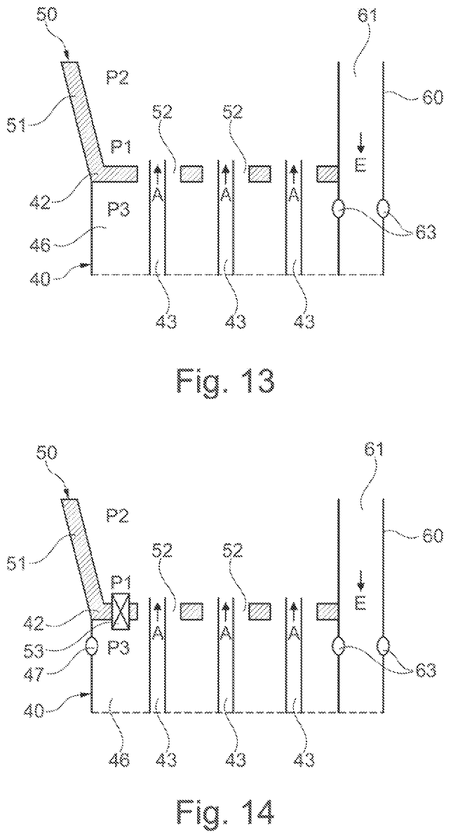

In the embodiment variant of FIG. 11, a plurality of heat transfer sector segments 40a-m is arranged side by side, and a plurality of flue gas tubes 60 is arranged between the sector segments 40a-m. The flue gas tubes 60 can thus be inserted, maintained and replaced particularly easily. In an alternative embodiment, the flue gas tubes 60 may also be arranged within the sector segments 40a. While in the exemplary embodiment of FIG. 11 the sector segments are shaped differently, other embodiments with a uniform shape of the heat transfer sector segments are also possible. In the embodiment variant of FIG. 12, two heat transfer sector segments 40a, 40b are arranged coaxially with respect to each other, and a plurality of flue gas tubes 60 is arranged within each of the sector segments 40a, 40b. In this exemplary embodiment, the inner sector segment 40a also includes a central additive tube 45. For example, the burner 20 can be operated using only the inner sector segment 40a when process air flow rates are low, and the outer sector segment 40b can be added when process air flow rates are higher. Due to the closest possible coupling of the sector segments 40n to each other, in these embodiment variants the connecting tubes 50 of the burners 20 better do not have sloping outer circumferential walls 51 (see FIGS. 13 and 14), and better no external introduction of flue gas E via additional external introduction openings 47 into the internal spaces 46 of the heat transfer sectors 40 is provided.

FIGS. 13 and 14 illustrate exemplary further design variants of the recuperative burner 20, in particular its support element 42 and its flame tube 50.

As already mentioned, the process air tubes 43 are preferably loosely coupled into the support element 42 of the heat transfer sector 40, i.e., surrounded by openings or gaps 52 in the support element 42, so that they can be individually pushed into the combustion chamber 12 in the event of elongation due to heat. Since the pressure in the flame tube 50 is by default significantly higher than in the internal space 46 of the heat transfer sector 40, there would be a risk, due to the gaps 52, that part of the still untreated process air A or the combustion air mixture C would immediately flow back into the internal space 46 and mix therein with the flue gas E due to the pressure difference. For this reason, the flame tube 50 provided/mounted on the support element 42 preferably has outer circumferential walls 51 that are inclined outwardly at an angle toward the combustion chamber 15, as shown in FIG. 13. This orientation of the outer circumferential walls 51 widens the cross-sectional area of the flame tube 50 and thus the space enclosed by the flame tube 50 in the direction towards the combustion space 15, whereby the process air A or the combustion air mixture C is spread more, which gives rise to other pressure conditions in the flame tube 50. In particular, the pressure P1 close to the support element 42 becomes significantly lower than the pressure P2 away from the support element 42, so that the pressure P1 becomes only insignificantly higher or even lower than the pressure P3 in the internal space 46. As a result, the process air A or the combustion air mixture C does not flow back through the gaps 52 into the internal space 46 of the heat transfer sector 40. Alternatively or in addition to the special orientation of the outer circumferential walls 51 of the flame tube 50, the walls of the flue gas tube 60 may also have special orientations for this purpose.

In the embodiment of the heat transfer sector 40 with the additional outer lead-in opening 467, however, there would still be the possibility, despite the inclined outer circumferential walls 51 of the flame tube 50, that some of the process air A or of the combustion air mixture C does not flow further into the combustion space 15 due to the large pressure difference between P2 and P3, but flows around the outer circumferential wall 51 of the flame tube 50 directly into the discharge gap of the flue gas between the combustion chamber housing 14 and the flame tube 50 and thus flows back into the interior 46 of the heat transfer sector 40 through the additional outer lead-in opening 47. As illustrated in FIG. 14, the support element 42 of the heat transfer sector 40 therefore preferably has in the outer region an additional opening in which a twister 53 is arranged for the oblique return of the flue gas E together with the potentially inflowing process air A from the internal space 46 into the flame tube 50. Even if no process air A flows back into the interior 46 untreated, this recirculation of the flue gas E is not disadvantageous, since the treatment effect is enhanced by the thermal treatment repeated in this way.

While in the above exemplary embodiments the thermal process air treatment device 10 each includes one recuperative burner 20, it is also possible in the context of examples disclosed herein to insert multiple (i.e., two or more) recuperative burners 20 into a combustion chamber 12 in accordance with examples disclosed herein. The number of burners 20 can be adapted to the operational requirements of the device 10 depending on the application. Furthermore, the multiple burners 20 are preferably independently controllable so that the operation of the process air treatment device 10 can also be adapted to the current operating requirements (in particular process air flow rate). Due to this modularity of the recuperative burners 20, they can preferably also be made somewhat smaller, in particular uniformly smaller (instead of different sizes for different operating requirements), which simplifies manufacturing, maintenance, quality assurance, etc., and can be easily used in larger numbers as needed.

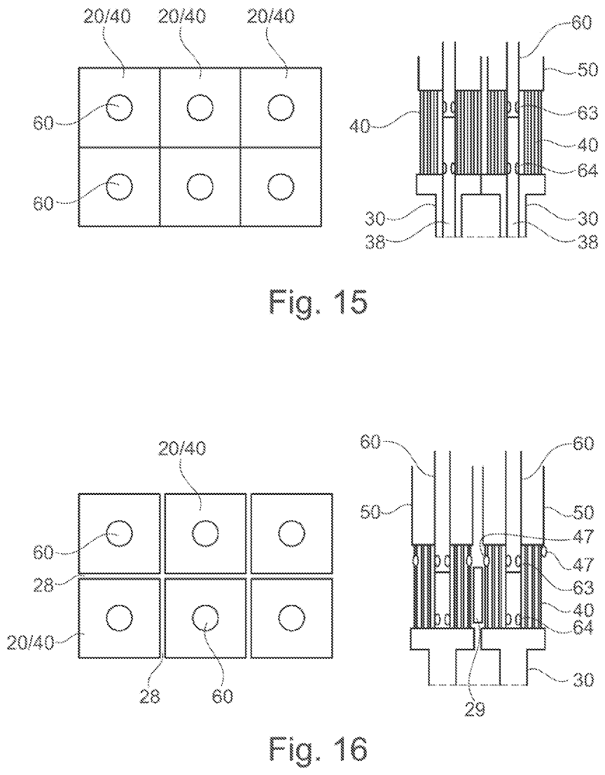

FIG. 15 shows an exemplary embodiment having six burners 20, each of which includes a single central flue gas tube 60 in its heat transfer sectors 40. In the exemplary embodiment of FIG. 15, the multiple burners 20 are arranged directly adjacent to each other. As can be seen in the right partial figure of FIG. 15, this is possible in particular if the flame tubes 50 of the burners 20 do not have any sloping outer circumferential walls 51 (see FIGS. 13 and 14) and if no external introduction of flue gas E via additional external lead-in openings 47 into the internal spaces 46 of the heat transfer sectors 40 is provided.

FIG. 16 also shows an exemplary embodiment having six burners 20, each of which includes a single central flue gas tube 60 in its heat transfer sectors 40. However, in the exemplary embodiment of FIG. 16, the plurality of burners 20 is each spaced somewhat apart. In the region of the corresponding burner gaps 28 between adjacent burners 20, burner partitions 29 are then preferably inserted between the adjacent heat transfer sectors 40 to close off the burner gaps 28 to prevent flue gas flow between the burners 20, as can be seen in the right partial figure of FIG. 16. However, due to the spacing between the adjacent burners 20, it is also possible in this embodiment to use flame tubes 50 with inclined outer circumferential walls 51 and/or external introductions of flue gas E into the internal spaces 46 of the heat transfer sectors 40 via additional external lead-in openings 47.

In FIGS. 15 and 16, the recuperative burners 20 each have a substantially square cross-sectional shape. In principle, the recuperative burners 20 of examples disclosed herein can have any cross-sectional shape (for example circular, elliptical, rectangular, or polygonal), but in modular use of the burners 20, rectangular or square cross-sectional shapes are more suitable for arranging the burners close together or even directly adjacent to each other.

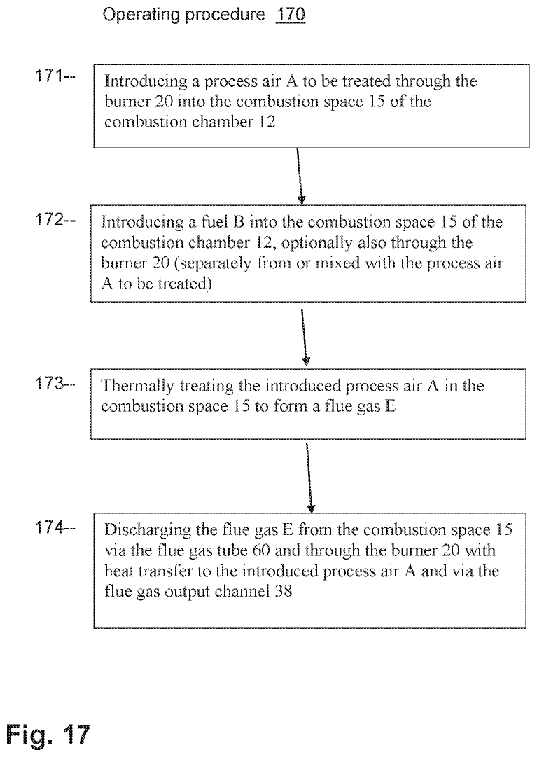

FIG. 17 illustrates an example of an operating method 170 of the recuperative burner 20 in the thermal process air treatment device 10, which is applicable to all of the above-described exemplary embodiments of FIGS. 1 to 16.

In step 171, a process air A to be treated is introduced into the combustion space 15 of the combustion chamber 12 by the recuperative burner 20, wherein the process air A to be treated is introduced into the combustion space 15 of the combustion chamber 12 through its connecting sector 30 and its heat transfer sector 40, according to the design of the recuperative burner 20 according to examples disclosed herein. In step 172, a fuel B is also introduced into the combustion space 15 of the combustion chamber 12. For example, depending on the embodiment of the recuperative burner 20 and the process air treatment device 10, the fuel B is introduced directly into the combustion space 15 through a fuel supply 19 (see, e.g., FIG. 1) and/or is introduced into the combustion space 15 through the burner 20 (see, e.g., FIGS. 3-10), wherein the introduction of the fuel B through the burner 20 into the combustion space 15 takes place separately from (see, e.g., FIGS. 5A, 5B) or mixed with (see, e.g., FIGS. 3, 6) the process air A to be treated, depending on the embodiment of the recuperative burner 20. The sequence of these two steps 171 and 172 is basically arbitrary.

After the fuel B and the process air A to be treated have been introduced into the combustion space 15 of the combustion chamber 12, the introduced process air A is thermally treated, in particular thermally oxidized, in the combustion space 15 in step 173. During this thermal treatment of the process air A, the flue gas E is formed in the combustion space 15. This flue gas E is in step 174 discharged from the combustion space 15 via the at least one flue gas tube 60 and is passed through the recuperative burner 20 with heat transfer to the introducing process air A (in the heat transfer sector 40 of the burner 20) and is discharged from the process air treatment device 10 via the flue gas output channel 38. The course of this flue gas conduit varies somewhat depending on the embodiment of the recuperative burner 20, as can be seen in the exemplary embodiments explained above. And the discharge of the flue gas E can optionally be varied by the actuators and/or variators explained above.

The scope of protection of examples disclosed herein is defined by the appended set of claims. The exemplary embodiments explained above, including variants thereof, serve in particular to provide a better understanding of examples disclosed herein, but are not intended to limit the scope of protection. The skilled person will be able to recognize further embodiment variants within the scope of protection of examples disclosed herein, which are based, for example, on further combinations of features of the above exemplary embodiment, further combinations of one or more of the above exemplary embodiments (i.e., not only explicitly mentioned combination examples), on individual omitted features of the above exemplary embodiments and/or on individual modified features of the above embodiment examples. For example, the all exemplary embodiments of FIGS. 3 to 14 can also be combined with the second exemplary embodiment of FIG. 2, i.e., the heat transfer sector 40 of the recuperative burner 20 can be supplemented in all embodiments by at least one additional insertion opening 47 as described in the second exemplary embodiment of FIG. 2.

### LIST OF REFERENCE SIGNS

10 thermal process air treatment device
12 combustion chamber
14 combustion chamber housing
15 combustion space
16 housing opening
18 heating device
19 fuel supply
20 recuperative burner
24 burner wall
26 burner flange
28 burner gaps
29 burner partition walls
30 connecting sector
31 process air input channel
32 process air valve device
33 fuel input channel
34 fuel valve device
35 premixing space
36 additive input channel
37 additive valve device
38 flue gas output channel
39a temperature detection device
39b temperature detection device
40 heat transfer sector
40n heat transfer sector segments
41 input manifold
42 support element
43 process air tubes
44a fuel tube between process air tubes
44b fuel tube inside process air tube
45 additive tube
46 internal space
47 additional lead-in opening
48 outside lead-out opening
49 baffle
50 flame tube
51 inclined outer wall
52 gaps/openings in exit flange
53 twister
60 flue gas tube
61 input opening
62 temperature detection device
63 tube wall openings
64 further tube wall openings
66 tube end wall
67 tube partition wall
67a lead-in section
67b discharge section
70 discharge opening
71 flue gas discharge channel
72 flow regulator
81 actuator in 38
82 actuator in 60
84 variator at 63
85 variator at 64
86 variator at 47
88 variator at 67
A process air
B fuel
C combustion air mixture
D additive
E flue gas
d12/t12 inner diameter/depth of the combustion chamber
d35/t35 inner diameter/depth of the premixing space
d38 inner diameter of the flue gas output channel
d40 inner diameter of the heat transfer sector
d50/t50 diameter/length of the flame tube
d60 inner diameter of the flue gas tube

1. A recuperative burner for a thermal process air treatment device having a combustion chamber with a combustion space therein for thermally treating a process air, the recuperative burner being configured for introducing a process air to be treated into the combustion space of the combustion chamber and for discharging a flue gas produced by thermal treating the process air from the combustion space of the combustion chamber with heat transfer from the discharging flue gas to the inflowing process air, the recuperative burner comprising:
a connecting sector including at least one process air input channel for receiving the process air and at least one flue gas output channel for outputting the flue gas;
a heat transfer sector including an input manifold attached to the connecting sector and a support element facing the combustion space of the combustion chamber, between which there is an internal space in which a plurality of process air tubes extend from the input manifold to the support member, to guide the process air from the connecting sector to the combustion space, the process air tubes being coupled through the input manifold to the at least one process air input channel of the connecting sector and being open through the support element in the direction towards the combustion space; and
at least one flue gas tube for discharging the flue gas from the combustion space, the at least one flue gas tube including an open input opening in the combustion space and passing through the support element of the heat transfer sector into the heat transfer sector and including, in the section inside the heat transfer sector, at least one tube wall opening for introducing the flue gas into the internal space of the heat transfer sector through which the process air tubes pass for the purpose of heat transfer from the discharging flue gas to the inflowing process air,
wherein the internal space of the heat transfer sector is coupled in its end region facing the connecting sector to the at least one flue gas output channel to discharge the flue gas from the heat transfer sector and from the burner.

2. The recuperative burner according to claim 1, wherein the heat transfer sector in its end region facing the combustion space further includes in its outer circumferential region at least one additional lead-in opening for introducing the flue gas from the combustion space into the internal space of the heat transfer sector through which the process air tubes pass.

3. The recuperative burner according to claim 1, further including a flame tube provided at the side of the support element of the heat transfer sector facing away from the internal space to introduce the process air into the combustion space via the flame tube, wherein the flue gas tube extends through the flame tube and through the support element of the heat transfer sector into the heat transfer sector.

4. The recuperative burner according to claim 1, wherein the flue gas tube projects into the heat transfer sector only along a partial section and has a closed tube end wall.

5. The recuperative burner according to claim 1, wherein:
the flue gas tube extends through the entire heat transfer sector to the input manifold and includes a closed tube end wall,
at least one of the at least one tube wall opening for introducing the flue gas into the internal space of the heat transfer sector is arranged in the half of the heat transfer sector facing the connecting sector, and
the heat transfer sector includes, in its end region facing the connecting sector, on its outer circumference at least one lead-out opening which is coupled to the at least one flue gas output channel.

6. The recuperative burner according to claim 1, wherein:
the flue gas tube extends through the entire heat transfer sector and through the input manifold,
the flue gas tube includes a tube partition wall between the region of the support element and the region of the input manifold to form a lead-in section facing the support element and a discharge section facing the input manifold, the discharge section being coupled to the at least one flue gas output channel,
the at least one tube wall opening for introducing the flue gas into the internal space of the heat transfer sector is arranged in the lead-in section, and
the flue gas tube includes at least one further tube wall opening in its discharge section for discharging the flue gas from the internal space of the heat transfer sector into the flue gas tube.

7. The recuperative burner according to claim 1, further including:
(i) at least one actuator configured and arranged to selectively at least partially block the flue gas output channel; and/or
(ii) at least one actuator configured and arranged to selectively at least partially block at least one of the at least one flue gas tube.

8. The recuperative burner according to claim 1, further including:
(iii) at least one variator configured and arranged to selectively at least partially restrict access to at least one of the at least one tube wall opening of the flue gas tube; and/or
(iv) at least one variator configured and arranged to selectively at least partially restrict access to at least one of the at least one further tube wall opening of the flue gas tube; and/or
(v) at least one variator configured and arranged to selectively at least partially restrict access to at least one of the at least one additional lead-in opening into the internal space of the heat transfer sector; and/or
(vi) at least one variator configured and arranged to selectively at least partially open the tube partition wall between the lead-in section and the discharge section of the flue gas tube.

9. The Recuperative burner according to claim 1, wherein the heat transfer sector includes, at a location between the support element and the input manifold at its outer periphery, at least one discharge opening for discharging a portion of the flue gas from the internal space of the heat transfer sector into a flue gas discharge channel, the discharge opening preferably being provided with a flow regulator for selectively adjusting a flue gas discharge amount.

10. The recuperative burner according to claim 1, wherein the heat transfer sector includes in its internal space a plurality of baffles each oriented transversely to the process air tubes and each having through openings for passing the process air tubes therethrough, the plurality of baffles being spaced apart from each other in the running direction of the process air tubes and being offset from each other in the direction transverse to the running direction of the process air tubes.

11. The recuperative burner according to claim 1, wherein the connecting sector further includes at least one fuel input channel for receiving a fuel and a premixing space for mixing the process air and the fuel to a combustion air mixture, wherein the process air tubes of the heat transfer sector are coupled to the premixing space through the input manifold to conduct the combustion air mixture from the connecting sector to the combustion space, wherein the connecting sector further includes at least one temperature detecting device for detecting a temperature of the combustion air mixture in the premixing space.

12. The recuperative burner according to claim 1, wherein
the connecting sector further includes at least one fuel input channel for receiving a fuel, and
the burner further includes at least one fuel tube coupled to the at least one fuel input channel and extending between the process air tubes or within a process air tube through the internal space of the heat transfer sector to direct the fuel separately to the process air from the connecting sector to the combustion space.

13. The recuperative burner according to claim 1, wherein
the connecting sector further includes at least one additive input channel for receiving an additive, and
the burner further includes at least one additive tube coupled to the at least one additive input channel and extending through the heat transfer sector adjacent to the process air tubes in order to introduce an additive into the combustion chamber in addition to the process air.

14. The recuperative burner according to claim 1, wherein the process air tubes are each tapered at their end facing the combustion space and/or are loosely coupled into the support element of the heat transfer sector and/or at least a subset of the process air tubes has a flame stabilizer.

15. The recuperative burner according to claim 1, wherein the flame tube and/or the flue gas tube comprise include outer circumferential walls configured and oriented such that the space enclosed by the flame tube is expanded in the direction from the support element of the heat transfer sector to the combustion space.

16. The recuperative burner according to claim 1, wherein the support element of the heat transfer sector includes, adjacent to the process air tubes, at least one additional opening in which a twister is arranged for obliquely returning gas from the internal space of the heat transfer sector into the flame tube.

17. The recuperative burner according to claim 1, wherein the connecting sector includes at least one valve device for selectively opening or closing a respective input channel.

18. The recuperative burner according to claim 1, further including a differential pressure measuring device across the heat transfer sector.

19. The recuperative burner according to claim 1, wherein the heat transfer sector consists includes of a plurality of heat transfer sector segments, the plurality of heat transfer sector segments each containing at least one flue gas tube and/or at least one flue gas tube being disposed between at least two heat transfer sector segments.

20. A thermal process air treatment device comprising:
a combustion chamber having a combustion space therein for thermally treating a process air; and
at least one recuperative burner for introducing the process air to be treated into the combustion space and for discharging a flue gas produced by thermally treating the process air from the combustion space with a heat transfer from the discharging flue gas to the introducing process air, wherein the at least one recuperative burner is a recuperative burner according to claim 1.

21. The thermal process air treatment device according to claim 20, including a plurality of recuperative burners which are controllable independently of one another.

22. The thermal process air treatment device according to claim 20, wherein the combustion chamber includes at least one heating device for supplying thermal energy to the combustion chamber.

23. A method for operating a thermal process air treatment device according to claim 20, the method comprising:
introducing a process air to be treated through the recuperative burner into the combustion space of the combustion chamber;
thermally treating the introduced process air in the combustion space to form a flue gas; and
discharging the flue gas from the combustion space via the flue gas tube and through the recuperative burner with heat transfer to the introduced process air and via the flue gas output channel.
